(19) United States
(12) Patent Application Publication
(10) Pub. No.: US 2014/0092222 A1
(43) Pub. Date: Apr. 3, 2014

(54) STEREOSCOPIC IMAGE PROCESSING DEVICE, STEREOSCOPIC IMAGE PROCESSING METHOD, AND RECORDING MEDIUM

(71) Applicants: Ikuko Tsubaki, Osaka-shi (JP); Mikio Seto, Osaka-shi (JP); Hisao Hattori, Osaka-shi (JP); Hisao Kumai, Osaka-shi (JP)

(72) Inventors: Ikuko Tsubaki, Osaka-shi (JP); Mikio Seto, Osaka-shi (JP); Hisao Hattori, Osaka-shi (JP); Hisao Kumai, Osaka-shi (JP)

(73) Assignee: Sharp Kabushiki Kaisha, Osaka-shi, Osaka (JP)

(21) Appl. No.: 14/126,156

(22) PCT Filed: Apr. 2, 2012
(86) PCT No.: PCT/JP2012/058933

§ 371 Date: Dec. 13, 2013

(30) Foreign Application Priority Data
Jun. 21, 2011 (JP) 2011-137324

(51) Int. Cl. H04N 13/04

(52) U.S. Cl. CPC H04N 13/04
USPC 348/51

(57) ABSTRACT

To provide a stereoscopic image processing device that can display an image that can be easily viewed stereoscopically by a viewer even in the case where there is a difference other than parallax between viewpoint images by reducing the difference without calculating the size of the difference. A stereoscopic image display device (1) includes a reference viewpoint image selection unit (12) that selects one of a plurality of viewpoint images as a reference viewpoint image, a parallax calculation unit (13) that calculates a parallax map between the reference viewpoint image and the remaining viewpoint image, an image generation unit (14) that generates a new remaining viewpoint image that corresponds to at least the remaining viewpoint image from the parallax map and the reference viewpoint image, and a display unit (16) that displays a stereoscopic image that includes at least the new remaining viewpoint image as a display element.

### TECHNICAL FIELD

The present invention relates to a stereoscopic image processing device that performs processing for displaying a stereoscopic image by using a plurality of viewpoint images, a stereoscopic image processing method, and a computer-readable recording medium.

### BACKGROUND ART

A multi-view stereoscopic image display device performs stereoscopic display by using a plurality of images each of which has a parallax with respect to each other. Each of the plurality of images is referred to as a viewpoint image. A two-viewpoint stereoscopic image display device performs stereoscopic display by using a left-eye image and a right-eye image, and also in this case, each of the left-eye image and the right-eye image can be referred to as a viewpoint image.

In the related art, a method of image capturing using a multi-lens camera that is formed of a plurality of cameras being arranged side-by-side is a known example of a method of capturing a stereoscopic image. When images that are captured by cameras of a multi-lens camera are displayed on a stereoscopic image display device as viewpoint images, a stereoscopic image is observed. Parallax is deviation between coordinates of a subject in viewpoint images in the lateral direction and varies with the distance between the subject and a camera. However, there is a case where deviation occurs between viewpoint images not only in the lateral direction but also in the longitudinal direction. This is caused by factors such as positions of cameras, deviation of optical axes in the longitudinal direction, deviation around the optical axes in a rotation direction. In the case where optical axes are not parallel as in the case of image capturing by a cross method, deviation the degree of which varies in accordance with area occurs in the longitudinal direction because the slopes of epipolar lines of viewpoint images are different from each other. In addition, there is a case where deviations of luminance and color occur between viewpoint images. Examples of factors that cause such deviations are differences in characteristics between cameras and the light reflection anisotropy of a subject.

It is known that when a stereoscopic image in which there is a difference between viewpoints is displayed on a display device, image quality and ease of stereoscopic viewing are reduced. PTL 1 discloses a stereoscopic image correction method for adjusting positional deviation and rotational deviation between images. PTL 2 discloses a display device that corrects luminance.

In addition, there is a case where various differences such as difference of the degree of blurring occur between viewpoint images. The degree of any of such differences is not always uniform in an image, and in most cases, varies in accordance with area.

### CITATION LIST

### Patent Literature

PTL 1: Japanese Unexamined Patent Application Publication No. 2002-77947
PTL 2: Japanese Unexamined Patent Application Publication No. 2011-59658

### SUMMARY OF INVENTION

### Technical Problem

However, in display methods of the related art such as the technologies described in PTL 1 and PTL 2, since correction is performed in accordance with the degree of deviation, the degrees of various deviations need to be accurately calculated. In the case where an error occurs in calculation of the degrees of such deviations, correction cannot be correctly performed, and there is a possibility that a large error causes such deviations to be increased rather than to be decreased. In particular, in the case where various deviations occur at the same time, it is difficult to accurately calculate the degrees of the deviations on a pixel-by-pixel basis.

The present invention has been made in view of the above-described situation, and it is an object of the present invention to provide a stereoscopic image processing device that can display an image that can be easily viewed stereoscopically by a viewer even in the case where there is a difference other than parallax between viewpoint images by reducing the difference without calculating the size of the difference, and to provide a stereoscopic image processing method and a computer-readable recording medium.

### Solution to Problem

In order to solve the above problems, according to first technical means, a stereoscopic image processing device includes a reference viewpoint image selection unit that selects one of a plurality of viewpoint images as a reference viewpoint image, a parallax calculation unit that calculates a parallax map between the reference viewpoint image and the remaining viewpoint image, an image generation unit that generates a new remaining viewpoint image that corresponds to at least the remaining viewpoint image from the parallax map and the reference viewpoint image, and a display control unit that displays a stereoscopic image that includes at least the new remaining viewpoint image as a display element, wherein the image generation unit further generates a new viewpoint image that corresponds to the reference viewpoint image from the parallax map and the reference viewpoint image, and wherein the display control unit displays a stereoscopic image that includes the new viewpoint image and the new remaining viewpoint image as display elements.

According to second technical means, in the first technical means, the reference viewpoint image selection unit selects the reference viewpoint image by using image feature amounts of the plurality of viewpoint images.

According to third technical means, in the second technical means, one of the image feature amounts is contrast.

According to fourth technical means, in the second technical means, one of the image feature amounts is sharpness.

According to fifth technical means, in the second technical means, one of the image feature amounts is the number of flesh color pixels in a periphery of an image.

According to sixth technical means, in the first technical means, the reference viewpoint image selection unit selects a viewpoint image of a predetermined viewpoint as the reference viewpoint image.

According to the seventh technical means, in the first technical means, the image generation unit performs parallax adjustment in a case of generating the new remaining viewpoint image from the parallax map and the reference view image.

According to the eighth technical means, in the first technical means, the image generation unit further generates a viewpoint image of a new viewpoint that has a new viewpoint different from a viewpoint of the new remaining viewpoint image from the parallax map and the reference viewpoint image, and the display control unit displays a stereoscopic image that also includes the viewpoint image of a new viewpoint as a display element.

According to ninth technical means, a stereoscopic image processing device includes; a reference viewpoint image selection unit that selects one of a plurality of viewpoint images as a reference viewpoint image; a parallax calculation unit that calculates a parallax map of the reference viewpoint image and the remaining viewpoint image; an image generation unit that generates a new remaining viewpoint image that corresponds to at least the remaining viewpoint image from the parallax map and the reference viewpoint image; and a display control unit that displays a stereoscopic image that includes at least the new remaining viewpoint image as a display element, wherein the plurality of viewpoint images are frame images that form a moving picture. The stereoscopic image processing device further includes a scene change detection unit. The reference viewpoint image selection unit selects a viewpoint image of a viewpoint that is the same as that of a previous frame image as the reference viewpoint image in a case where a scene change is not detected in the scene change detection unit.

According to tenth technical means, in the ninth technical means, the image generation unit performs parallax adjustment in a case of generating the new remaining viewpoint image from the parallax map and the reference viewpoint image.

According to eleventh technical means, in the ninth technical means, the image generation unit further generates a viewpoint image of a new viewpoint that has a new viewpoint different from a viewpoint of the new remaining viewpoint image from the parallax map and the reference viewpoint image, and the display control unit displays a stereoscopic image that also includes the viewpoint image of a new viewpoint as a display element.

According to twelfth technical means, a stereoscopic image processing method includes the steps of selecting one of a plurality of viewpoint images as a reference viewpoint image by using a reference viewpoint image selection unit, calculating a parallax map between the reference viewpoint image and the remaining viewpoint image by using a parallax calculation unit, generating a new remaining viewpoint image that corresponds to the remaining viewpoint image from the parallax map and the reference viewpoint image by using an image generation unit, further generating a new viewpoint image that corresponds to the reference viewpoint image from the parallax map and the reference viewpoint image from the parallax ma and the reference viewpoint image by using the image generation unit; and displaying a stereoscopic image that includes the new viewpoint image and the new remaining viewpoint image as display elements by using a display control unit.

According to thirteenth technical means, a non-transitory computer readable recording medium recording a program causes a computer to execute a stereoscopic image process, the stereoscopic image process including the steps of selecting one of a plurality of viewpoint images as a reference viewpoint image, calculating a parallax map between the reference viewpoint image and the remaining viewpoint image, generating a new remaining viewpoint image that corresponds to the remaining viewpoint image from the parallax map and the reference viewpoint image, further generating a new viewpoint image that corresponds to the reference viewpoint image from the parallax map and the references viewpoint image; and displaying a stereoscopic image that includes the new viewpoint image and the new remaining viewpoint image as display elements.

### Advantageous Effects of Invention

According to the present invention, even in the case where there is a difference other than parallax between viewpoint images, the difference can be reduced without calculating the size of the difference, and a stereoscopic image of good image quality that can be easily viewed stereoscopically by a viewer can be displayed.

### BRIEF DESCRIPTION OF DRAWINGS

FIG. 1 is a block diagram illustrating a schematic configuration example of a stereoscopic image display device according to a first embodiment of the present invention.

FIG. 2 is a flow diagram for describing an operation example of an image generation unit in the stereoscopic image display device of FIG. 1.

FIG. 3 is a diagram for describing an operation example of a reference viewpoint image selection unit in a stereoscopic image display device according to a second embodiment of the present invention.

FIG. 4 is a block diagram illustrating a schematic configuration example of a stereoscopic image display device according to a third embodiment of the present invention.

FIG. 5 is a block diagram illustrating a schematic configuration example of a stereoscopic image display device according to a fourth embodiment of the present invention.

FIG. 6 is a block diagram illustrating a schematic configuration example of a stereoscopic image display device according to a sixth embodiment of the present invention.

FIG. 7 is a flow diagram for describing an operation example of an image generation unit in the stereoscopic image display device of FIG. 6.

FIG. 8 is a flow diagram for describing an operation example of an image generation unit in a stereoscopic image display device according to a seventh embodiment of the present invention.

### DESCRIPTION OF EMBODIMENTS

Various embodiments of the present invention will be described in detail below with reference to the accompanying drawings. In the drawings, portions that have the same functions are denoted by the same reference numerals, and repeated descriptions will be omitted.

### First Embodiment

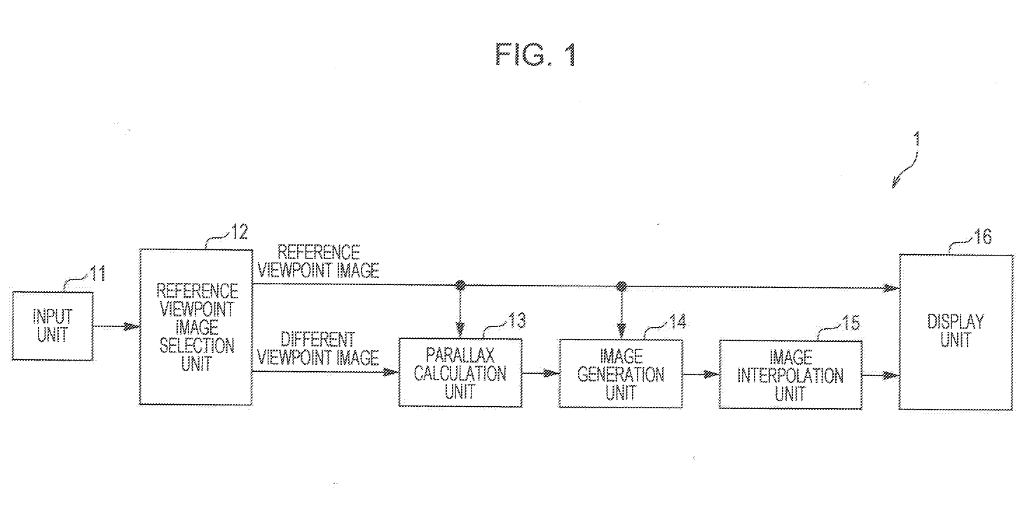

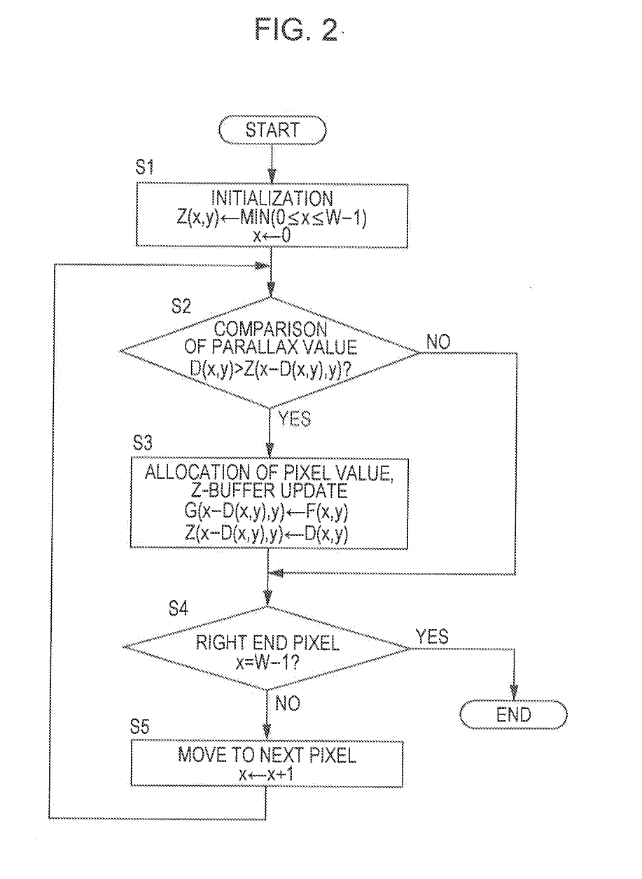

A first embodiment of the present invention will be described with reference to FIG. 1 and FIG. 2. FIG. 1 is a block diagram illustrating a schematic configuration example of a stereoscopic image display device according to the first embodiment of the present invention. FIG. 2 is a flow diagram for describing an operation example of an image generation unit in the stereoscopic image display device of FIG. 1 and is a diagram for describing a procedure of the image generation unit according to the first embodiment of the present invention.

As illustrated in FIG. 1, a stereoscopic image display device 1 of the present embodiment includes an input unit 11, a reference viewpoint image selection unit 12, a parallax calculation unit 13, an image generation unit 14, an image interpolation unit 15, and a display unit 16. The display unit 16 is formed of a display device and a display control unit that performs control for outputting a stereoscopic image to the display device.

The input unit 11 inputs a plurality of viewpoint images to the reference viewpoint image selection unit 12 as input images. The input unit 11 may be formed in such a manner as to be able to input a plurality of viewpoint images by using any one of the following obtaining methods: a method of obtaining viewpoint images by, for example, image capturing using a camera, a method of obtaining viewpoint images by receiving a broadcast wave of digital broadcasting and performing processing such as demodulation on the broadcast wave, a method of obtaining viewpoint images from an external server or the like via a network, a method of obtaining viewpoint images from a local storage device or a transportable recording medium, and the like. In addition, the input unit 11 may be formed in such a manner as to be able to input a plurality of viewpoint images by using a plurality of the obtaining methods.

The reference viewpoint image selection unit 12 selects one of a plurality of viewpoint images as a reference viewpoint image. An example in which input images that are to be input via the input unit 11 are formed of a left-eye image and a right-eye image, that is, an example in which a plurality of viewpoint images are a left-eye image and a right-eye image will be described below. Since a left-eye image and a right-eye image are used in this example, in the reference viewpoint image selection unit 12, one of the left-eye image and the right-eye image is selected as a reference viewpoint image, and the other one of the left-eye image and the right-eye image is determined as a different viewpoint image.

A reference viewpoint image is selected on the basis of contrast of images. First, the contrast C of each of the left-eye image and the right-eye image is calculated from an expression (1).

C=(Imax−Imin)/(Imax+Imin) (1)

In the above expression, Imax and Imin are a maximum value and a minimum value of the luminance of pixels in each of the images, respectively. One of the images having a contrast C that is higher than that of the other one of the images is determined as a reference viewpoint image, and the other one of the images having a contrast C that is lower than that of the one of the images is determined as a different viewpoint image. In the case where the value of the contrast C of the left-eye image and the value of the contrast C of the right-eye image are the same as each other, a predetermined one of the images is determined as a reference viewpoint image, and the other one of the images is determined as a different viewpoint image. Through this processing, the one of viewpoint images that has a better image quality can be selected as a reference viewpoint image. The reference viewpoint image is input to the parallax calculation unit 13, the image generation unit 14, and the display unit 16, and the different viewpoint image is input only to the parallax calculation unit 13.

In the alternative method of selecting a reference viewpoint image in the reference viewpoint image selection unit 12, one of the images that has a higher sharpness is selected. Sharpness is defined by, for example, a total value of absolute value sums of a difference of luminance value between adjacent pixels in the lateral direction and a difference of luminance value between adjacent pixels in the longitudinal direction in the entire image. Alternatively, a plurality of image feature amounts such as contrast and sharpness may be combined. Such a combination is made by, for example, calculating a linear sum of a plurality of feature amounts. By combining such feature amounts, a reference viewpoint image can be selected while further precisely considering an image quality that is felt by a viewer when the viewer watches the image. As described above, the reference viewpoint image selection unit 12 may select a reference viewpoint image by using image feature amounts of a plurality of viewpoint images and alternatively may select an image of a predetermined viewpoint as a reference viewpoint image. Processing amount can be reduced by fixing a viewpoint image to be selected.

In the parallax calculation unit 13, a parallax map between the reference viewpoint image and each of remaining viewpoint images, that is, in this example, parallax maps between different viewpoint images and the reference viewpoint image is calculated. In a parallax map, difference values between coordinates of pixels of the different viewpoint images and corresponding points in the reference viewpoint image in the lateral direction (the horizontal direction) are recorded. Various methods using block matching, dynamic programming, graph cut, and the like are known as methods of calculating a parallax map. Although any of these methods may be used, a parallax map is calculated by using a method that is robust to differences of deviation in the longitudinal direction, luminance, color, and the like.

In the image generation unit 14, new remaining viewpoint images that correspond to at least the above-described remaining viewpoint images are generated from the reference viewpoint image and the parallax maps. In other words, the different viewpoint images are reconfigured from the reference viewpoint image and the parallax maps, so that new remaining viewpoint images (different viewpoint images to be displayed) are generated. In a reconfiguration method, a parallax value of coordinates of each pixel of the reference viewpoint image is read from the parallax maps, and each of the pixel values is copied to a pixel having coordinates that are moved by the parallax value in the different viewpoint images to be displayed. Although this process is performed on all of the pixels in the reference viewpoint image, in the case where a plurality of pixel values are allocated to one same pixel, the pixel value of a pixel having a parallax value that is maximum in a pop-up direction is used on the basis of z-buffer algorithm.

The procedure of the reconfiguration method of the image generation unit 14 will be described with reference to FIG. 2. FIG. 2 is an example in which a left-eye image is selected as a reference viewpoint image. Although (x, y) represents coordinates in the image, FIG. 2 illustrates a process that is performed in each of rows, and y is constant. F, G, and D represent a reference viewpoint image, a different viewpoint image to be displayed, and a parallax map, respectively. Z is an array for holding a parallax value of each of pixels in the different viewpoint image to be displayed in the process and is referred to as a z-buffer. W is the number of pixels of the image in the horizontal direction.

First, in step S1, the z-buffer is initialized with an initial value MIN. The parallax value is a positive value in the pop-up direction and is a negative value in a depth direction, and MIN is a value less than the minimum value of parallax that is calculated in the parallax calculation unit 13. In addition, in order to perform the process in order starting from the leftmost pixel in subsequent steps, 0 is input to x. In step S2, a parallax value of the parallax map and the z-buffer value of a pixel having coordinates that are moved by the parallax value are compared so as to determine whether the parallax value is larger than the z-buffer value or not. In the case where the parallax value is larger than the z-buffer value, the process continues to step S3, and the pixel value of the reference viewpoint image is allocated to the different viewpoint image to be displayed. In addition, the z-buffer value is updated.

Next, in step S4, in the case where current coordinates represent the rightmost pixel, the process is exited, and otherwise, the process continues to step S5 and returns to step S2 after moving to an adjacent pixel on the right side. In step S2, in the case where the parallax value is not more than the z-buffer value, the process continues to step S4 without performing step S3. This procedure is performed on all of the rows. Since reconfiguration is performed by moving coordinates by the parallax value only in the lateral direction, a different viewpoint image to be displayed that does not have a difference other than parallax from the reference viewpoint image can be generated.

The image interpolation unit 15 performs interpolation processing on a pixel, to which a pixel value has not been allocated in the image generation unit 14, of the different viewpoint image to be displayed, which has been generated in the image generation unit 14, and allocates a pixel value to the pixel. The interpolation processing is performed by using an average value of the pixel value of a pixel to which a pixel value has been allocated and which is closest to a pixel to which a pixel value has not been allocated on the left side and the pixel value of a pixel to which a pixel value has been allocated and which is closest to the pixel to which a pixel value has not been allocated on the right side. This interpolation processing is not limited to a method in which an average value is used and may be other methods such as filter processing. As described above, the image interpolation unit 15 is mounted, so that the interpolation processing is performed on a pixel, to which a pixel value has not been allocated, of a different viewpoint image that has been generated, and as a result, pixel values can always be determined.

The display control unit in the display unit 16 displays a stereoscopic image that includes at least the above-described new remaining viewpoint images (the different viewpoint images to be displayed) as display elements on the display device. In the present embodiment, the reference viewpoint image is used as it is. In other words, the display control unit in the display unit 16 displays a stereoscopic image that includes the reference viewpoint image and the above-described new remaining viewpoint images as display elements on the display device. Although the display unit 16 is formed of the display control unit and the display device as described above, processing in the display unit 16 will be simply described in the following description including descriptions of other embodiments.

Since a two-viewpoint stereoscopic display is herein described as an example, the reference viewpoint image and the different viewpoint image to be displayed are input to the display unit 16, and stereoscopic display is performed. In the case where the left-eye image is selected as the reference viewpoint image in the reference viewpoint image selection unit 12, the reference viewpoint image and the different viewpoint image to be displayed are displayed as the left-eye image and the right-eye image, respectively. In the case where the right-eye image is selected as the reference viewpoint image in the reference viewpoint image selection unit 12, the reference viewpoint image and the different viewpoint image to be displayed are displayed as the right-eye image and the left-eye image, respectively.

As described above, according to the stereoscopic image display device of the present embodiment, one of viewpoint images is reconfigured from the other one of viewpoint images, so that even in the case where there is a difference (deviation in the longitudinal direction, color deviation, or the like) other than parallax between the viewpoint images, the difference can be reduced without calculating the degree of the difference, and a stereoscopic image of good image quality that can be easily viewed stereoscopically by a viewer can be displayed. For example, even if instrumental errors or the degrees of deterioration of a light receiving element for a right eye and a light receiving element for a left eye are different from each other in an image that is captured by a twin-lens camera and that is input, the difference can be reduced. In addition, reconfiguration is performed by using an image that has a high contrast and a high sharpness as a reference, so that a stereoscopic image that that has a high contrast and a high sharpness can be displayed.

### Second Embodiment

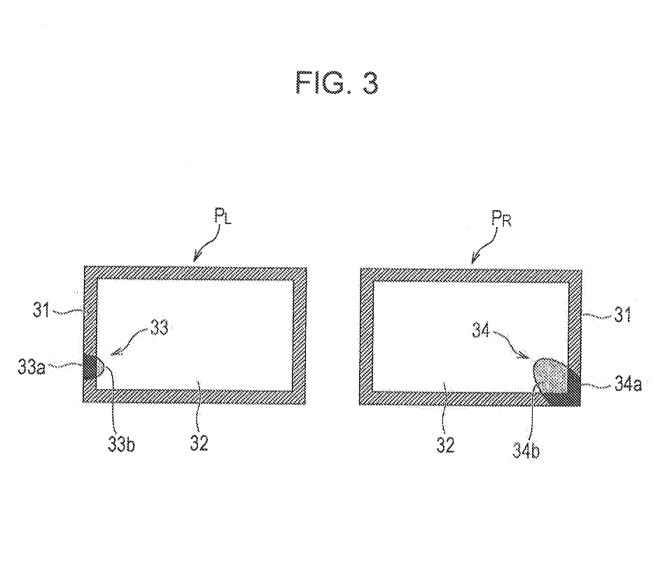

A second embodiment of the present invention will be described with reference to FIG. 3. FIG. 3 is a diagram for describing an operation example of a reference viewpoint image selection unit in a stereoscopic image display device according to the second embodiment of the present invention.

Although a schematic configuration example of the stereoscopic image display device in the second embodiment is illustrated in FIG. 1 like the first embodiment, the processing method in the reference viewpoint image selection unit 12 is different from that of the first embodiment. In the present embodiment, images that are captured while a lens is partly blocked by a finger are detected, and one of viewpoint images that has a smaller area that is blocked by a finger than that of the other one of the viewpoint images is selected as a reference viewpoint image.

In the reference viewpoint image selection unit 12, first, in each of the left-eye image and the right-eye image, pixel values of pixels located in a region that has a constant width from the left and right ends and the upper and lower ends of the image is converted into HSV color space. Next, a pixel having an H value that is within a predetermined range is considered as flesh color, and the number of flesh color pixels in each of the images is counted. Then, in the case where the number of flesh color pixels is a predetermined threshold or smaller in both the left-eye image and the right-eye image, it is determined that a lens was not partly blocked by a finger during an image capturing, and a reference viewpoint image is selected by a method the same as that of the first embodiment. In the case where the number of flesh color pixels is larger than the predetermined threshold in any one of the images, the one of the images that has a smaller number of flesh color pixels than the other one of the images is selected as a reference viewpoint image, and the other one of the images is determined as a different viewpoint image.

An image P_{L} and an image P_{R} that are illustrated in FIG. 3 are respectively examples of a left-eye image and a right-eye image that are captured while a lens is partly blocked by a finger. In the left-eye image P_{L} and the right-eye image P_{R}, black portions 33a and 34a and hatching portions 33b and 34b represent regions 33 and 34 of fingers that are captured in the images, and in this example, a finger is captured in a left end portion of the left-eye image P_{L} and in a right bottom corner of the right-eye image P_{R}. In each of the left-eye image P_{L} and the right-eye image P_{R}, a shaded portion 31 is a region that has a constant width from the left and right ends and the upper and lower ends of the image and that is to be used for detecting the number of flesh color pixels. The black portions 33a and 34a are regions that are included in the number of flesh color pixels. In this example, the number of flesh color pixels (the number of pixels of the black portion) in the left-eye image P_{L} is smaller than that in the right-eye image P_{R}, and thus, the left-eye image P_{L} is selected as a reference viewpoint image.

In addition, in the case where the number of flesh color pixels in the periphery of an image is employed as one of image feature amounts used in the reference viewpoint image selection unit 12 as described above, a plurality of image feature amounts such as contrast and sharpness may be used in combination with each other. Such a combination is made by, for example, calculating a linear sum of a plurality of feature amounts. Most simply, in the case where a difference in the number of flesh color pixels is a predetermined number or greater, the one of the images that has a smaller number of flesh color pixels than the other one of the images may be selected as a reference viewpoint image disregarding other image feature amounts, and in the case where a difference in the number of flesh color pixels is lower than a predetermined number, a reference viewpoint image may be selected on the basis of other image feature amounts.

As described above, according to the stereoscopic image display device of the present embodiment, in the case of displaying images that are captured while a lens is partly blocked by a finger, the one of viewpoint images that has a smaller area that is blocked by a finger than that of the other one of the viewpoint image is reconfigured as a reference viewpoint image, and thus, a stereoscopic image in which an area that is blocked by the finger is small can be displayed.

### Third Embodiment

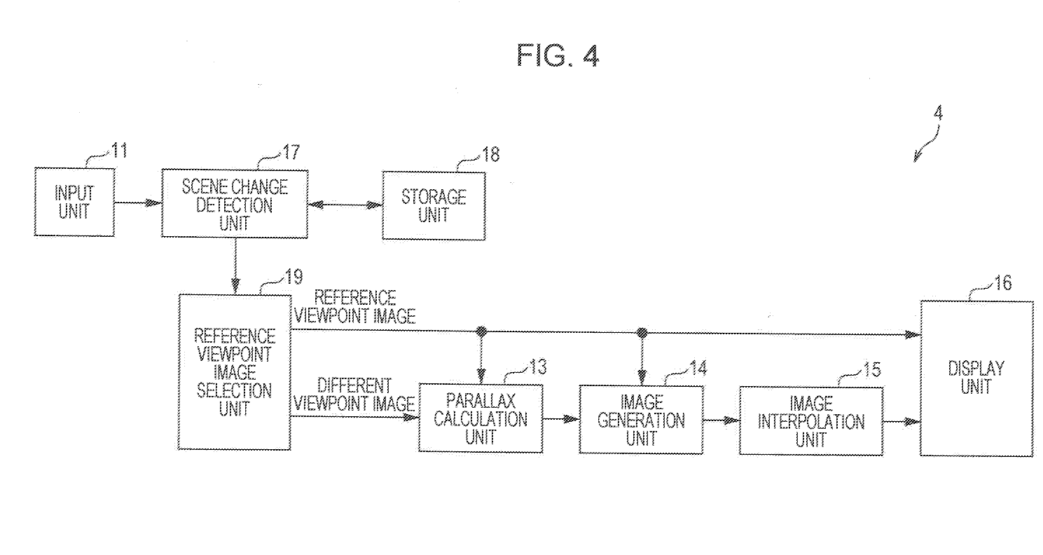

A third embodiment of the present invention will be described with reference to FIG. 4. FIG. 4 is a block diagram illustrating a schematic configuration example of a stereoscopic image display device according to the third embodiment of the present invention. In the third embodiment, an input image is limited to a moving picture. In other words, a plurality of viewpoint images are frame images that form the moving picture.

As illustrated in FIG. 4, a stereoscopic image display device 4 of the present embodiment includes an input unit 11, a scene change detection unit 17, a storage unit 18, a reference viewpoint image selection unit 19, a parallax calculation unit 13, an image generation unit 14, an image interpolation unit 15, and a display unit 16. The units that are denoted by the same reference numerals as the first embodiment have the same configurations as those of the first embodiment, and thus, description of the units will be omitted.

Since a two-viewpoint system is described as this example, frames of the input image that is to be input via the input unit 11 are formed of a left-eye image and a right-eye image and are input to the scene change detection unit 17. In the scene change detection unit 17, the frames are compared with a previous frame image stored in the storage unit 18 in order to detect whether a scene change occurs or not. A scene change is detected by, for example, comparing the luminance histograms of the frames. First, luminance values of pixels of an input frame that is input via the input unit 11 are calculated, and a histogram having a predetermined class is made. Next, similarly, a luminance histogram of the previous frame image that is read from the storage unit 18 is made. Then, a difference of frequencies between the two histograms is determined for each class, and an absolute value sum of the differences is calculated. In the case where the absolute value sum is a predetermined threshold or greater, it is determined that a scene change occurs, and the reference viewpoint image selection unit 19 is informed of the scene change. In addition, the previous frame image stored in the storage unit 18 is updated by an input frame image.

The scene change detection unit 17 may detect a scene change from a moving picture of one viewpoint (sequential frame images) and may detect a scene change from a moving picture of a plurality of viewpoints (sequential frame images). As a different detection method, a scene change may be detected by previously embedding a signal of a scene change in a moving picture of at least one viewpoint and detecting the signal or the like.

In the reference viewpoint image selection unit 19, the contents of processing is changed depending on whether a scene change is detected in the scene change detection unit 17 or not. In the case where a scene change is detected, a reference viewpoint image is selected by processing similar to that of the reference viewpoint image selection unit 12 of the first embodiment (or the second embodiment). In the case where a scene change is not detected, a viewpoint image of a viewpoint that is the same as the viewpoint that has been selected as a reference viewpoint image in the previous frame is selected as a reference viewpoint image. In other words, in the case where the left-eye image is selected as a reference viewpoint image in the previous frame image, a left-eye image of the current frame input image is output to the parallax calculation unit 13, the image generation unit 14, and the display unit 16 as a reference viewpoint image, and a right-eye image is output to the parallax calculation unit 13 as a different viewpoint image.

As described above, according to the stereoscopic image display device of the present embodiment, in the case where an input image is a moving picture, detection of a scene change is performed, and in a frame in which a scene change does not occur, an image of a viewpoint that is the same as that of a previous frame is reconfigured as a reference viewpoint image. Therefore, fluctuations between frames of a display image can be suppressed.

### Fourth Embodiment

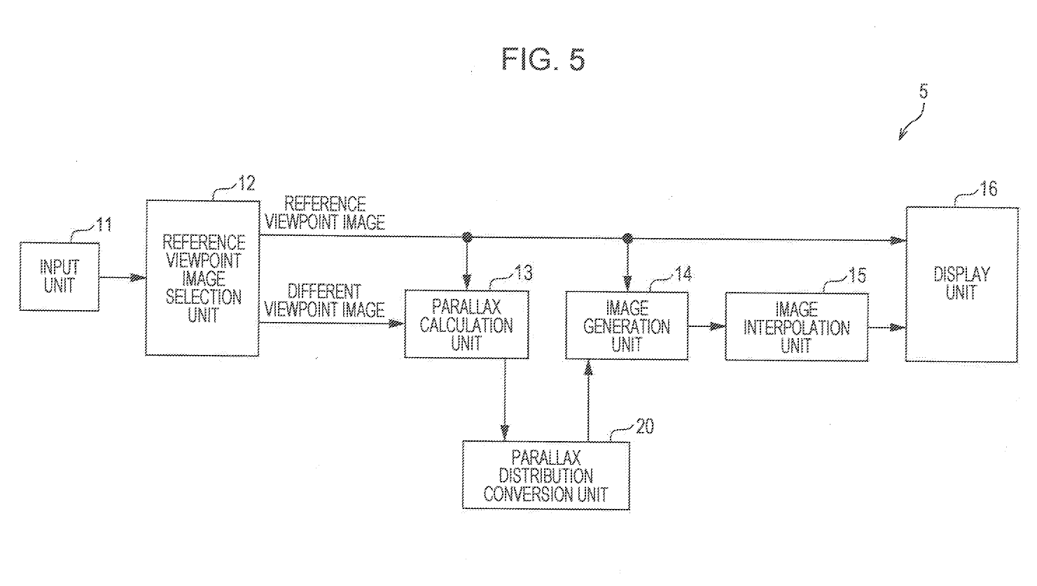

A fourth embodiment of the present invention will be described with reference to FIG. 5. FIG. 5 is a block diagram illustrating a schematic configuration example of a stereoscopic image display device according to the fourth embodiment of the present invention.

In the fourth embodiment, a difference other than parallax between viewpoint images is reduced as in the first to third embodiments, and at the same time, parallax adjustment is performed. As illustrated in FIG. 5, a stereoscopic image display device 5 of the present embodiment is the stereoscopic image display device 1 of FIG. 1 that further includes a parallax distribution conversion unit 20. However, in the present embodiment, a schematic configuration example of the stereoscopic image display device 4 of FIG. 4 that further includes the parallax distribution conversion unit 20 may be employed because the present embodiment can be applied to the third embodiment.

The image generation unit 14 of the present embodiment performs parallax adjustment when the above-described new remaining viewpoint images are generated from a parallax map and a reference viewpoint image. In FIG. 5, a unit that performs the parallax adjustment is illustrated as the parallax distribution conversion unit 20 that is separated from the image generation unit 14. In the parallax distribution conversion unit 20, a value of an input parallax map that is calculated by the parallax calculation unit 13 is converted, and a converted parallax map is output to the image generation unit 14. In a method of performing the conversion, for example, the following expression (2) is used. In the expression, p(x, y) and q(x, y) are an input parallax map and a converted parallax map, respectively, and a and b are constants.

q(x,y)=a·p(x,y)+b (2)

The range of parallax that is included in an image can be adjusted by using this expression.

As an example of other methods of performing the conversion, the following expression (3) may be used.

1/q(x,y)=a·(1/p(x,y))+b (3)

According to this expression, parallax adjustment can be performed while considering that the distance between an image that is reproduced by the stereoscopic image display device and a viewer is proportional to the reciprocal of the parallax.

In the image generation unit 14, a different viewpoint image to be displayed is generated by a method similar to that of the first embodiment (or the second or third embodiment) by using the converted parallax map that has been made by the parallax distribution conversion unit 20 and the reference viewpoint image.

As described above, according to the stereoscopic image display device of the present embodiment, a difference between viewpoint images can be reduced, and in addition, a stereoscopic image in which the range of parallax is adjusted can be displayed.

### Fifth Embodiment

A fifth embodiment of the present invention will be described with reference to FIG. 1 again. The fifth embodiment relates to a stereoscopic image display device that can reduce a difference between viewpoint images in the case of performing multi-view stereoscopic display. Although a schematic configuration example of the stereoscopic image display device of the present embodiment is illustrated in FIG. 1 like the first embodiment, input images that are input via the input unit 11 are multi-view images having three or more viewpoints. The number of viewpoints that form the input multi-view images is N. In the present embodiment, the number of viewpoints that form multi-view images to be displayed, that is, the number of multi-view images to be displayed is also N.

In the reference viewpoint image selection unit 12, one of N viewpoint images is selected as a reference viewpoint image, and remaining N−1 viewpoint images are determined as different viewpoint images. This selection is performed on the basis of, for example, the contrasts of the images. First, the contrast of each of the viewpoint images is calculated by the expression (1). Then, one of the images that has a highest contrast C is determined as a reference viewpoint image, and the remaining viewpoint images are determined as different viewpoint images. The reference viewpoint image is input to the parallax calculation unit 13, the image generation unit 14, and the display unit 16, and the N−1 different viewpoint images are input only to the parallax calculation unit 13. Although only the example in which the selection is performed on the basis of the contrasts of the images has been described, the selection may be performed in the similar manner on the basis of other elements such as sharpness.

In the parallax calculation unit 13, parallax maps of the reference viewpoint image in which the reference viewpoint image is compared with each of the different viewpoint images are calculated. The calculation of the parallax maps is performed by a method similar to that described in the first embodiment, and N−1 parallax maps are output to the image generation unit 14.

In the image generation unit 14, N−1 different viewpoint images to be displayed are generated from the reference viewpoint image and each of the parallax maps. The generation of each of the different viewpoint images to be displayed is performed by, in the similar manner to the first embodiment, reading the parallax value of coordinates of each of pixels in the reference viewpoint image and copying the pixel value to a corresponding pixel having coordinates that are moved by the parallax value in each of the different viewpoint images to be displayed.

The image interpolation unit 15 performs interpolation processing on a pixel, to which a pixel value has not been allocated, of each of the N−1 different viewpoint images to be displayed that have been generated by the image generation unit 14 and allocates a pixel value to the pixel. This interpolation processing is performed by a method similar to that of the first embodiment.

The reference viewpoint image and the N−1 different viewpoint images to be displayed are input to the display unit 16, and multi-view stereoscopic display is performed. A total of N viewpoint images are displayed by being placed in an appropriate order.

As described above, according to the stereoscopic image display device of the present embodiment, in the case of performing multi-view stereoscopic display having three or more viewpoints, a stereoscopic image in which a difference is reduced can be displayed by reconfiguring remaining viewpoint images from one viewpoint image (a reference viewpoint image).

### Sixth Embodiment

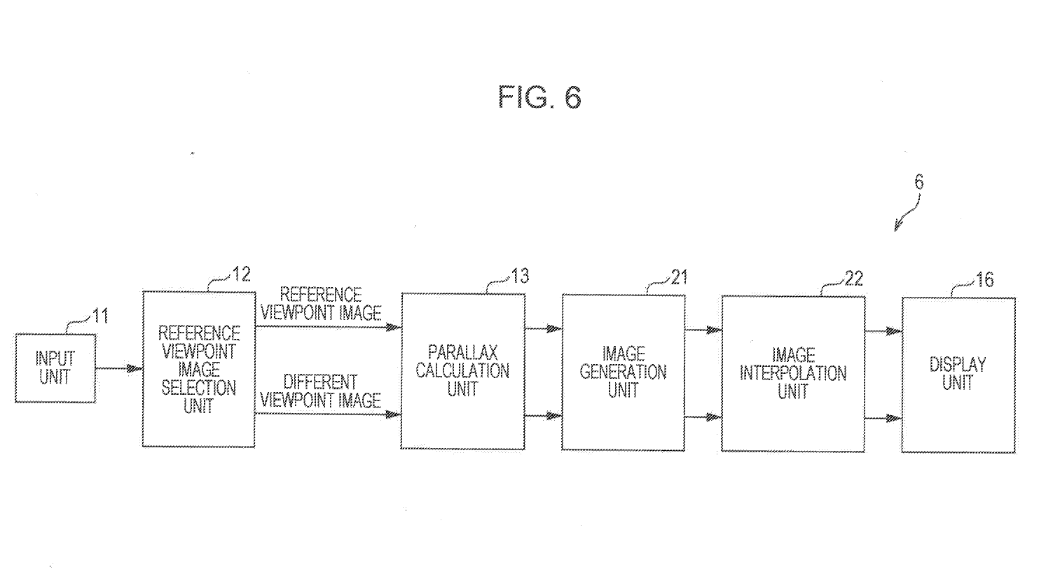

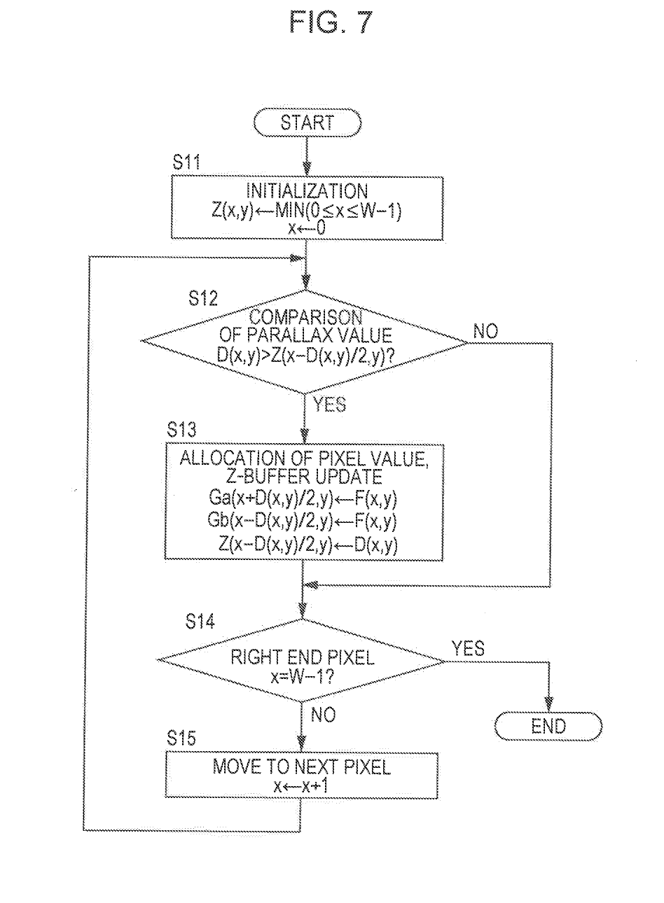

A sixth embodiment of the present invention will be described with reference to FIG. 6 and FIG. 7. FIG. 6 is a block diagram illustrating a schematic configuration example of a stereoscopic image display device according to the sixth embodiment of the present invention. FIG. 7 is a flow diagram for describing an operation example of an image generation unit in the stereoscopic image display device of FIG. 6 and is a diagram for describing a procedure of the image generation unit according to the sixth embodiment.

As illustrated in FIG. 6, a stereoscopic image display device 6 of the present embodiment includes an input unit 11, a reference viewpoint image selection unit 12, a parallax calculation unit 13, an image generation unit 21, an image interpolation unit 22, and a display unit 16. The units that are denoted by the same reference numerals as the first embodiment have the same configurations as those of the first embodiment, and thus, descriptions of the units will be omitted.

Although, in the first to fifth embodiments, the case where the display unit 16 displays a stereoscopic image that includes a reference viewpoint image and new remaining viewpoint images as display elements has been described, in the stereoscopic image display device 6 of the sixth embodiment, the image generation unit 21 also generates a new viewpoint image that corresponds to a reference viewpoint image and uses the new viewpoint image as one of display elements of a stereoscopic image in place of an existing reference viewpoint image.

Therefore, the image generation unit 21 of the present embodiment further generates a new viewpoint image that corresponds to a reference viewpoint image from parallax maps and the reference viewpoint image. In other words, in the image generation unit 21, a reference viewpoint image to be displayed and different viewpoint images to be displayed are generated from a reference viewpoint image and parallax maps that are calculated by the parallax calculation unit 13 and are output to the image interpolation unit 22. As a result, new viewpoint images that correspond to all of a plurality of viewpoint images that have been input are generated for display.

A procedure of a generation method of the image generation unit 21 will be described with reference to FIG. 7. FIG. 7 is an example in which a left-eye image is selected as a reference viewpoint image. Although, in a manner similar to FIG. 2, (x, y) represents coordinates in the image, FIG. 7 illustrates a process that is performed in each of rows, and y is constant. F, Ga, Gb, and D represent a reference viewpoint image, a reference viewpoint image to be displayed, a different viewpoint image to be displayed, and a parallax map, respectively. Similarly to FIG. 2, Z and W are a z-buffer and the number of pixels of the image in the lateral direction. Steps S11, S14, and S15 are the same as steps S1, S4, and S5 of FIG. 2, respectively, and thus, the descriptions of these steps will be omitted.

In step S12, a parallax value of the parallax map and the z-buffer value of a pixel having coordinates that are moved by a value that is half of the parallax value are compared so as to determine whether the parallax value is larger than the z-buffer value or not. In the case where the parallax value is larger than the z-buffer value, the process continues to step S13, and the pixel value of the reference viewpoint image F is allocated to the reference viewpoint image to be displayed Ga and the different viewpoint image to be displayed Gb. However, in each of the reference viewpoint image to be displayed Ga and the different viewpoint image to be displayed Gb, the pixel value of the reference viewpoint image F is allocated to the coordinates that are moved by the value, which is half of the parallax value, from coordinates (x, y) in an opposite direction. Regarding the z-buffer, the value of the coordinates that are moved by the value, which is half of the parallax value, is updated, and the process continues to step S14. In step S12, in the case where the parallax value is not greater than the z-buffer value, the process continues to step S14 without performing step S13. The procedure of FIG. 7 is performed on all of the rows, so that a reference viewpoint image to be displayed and a different viewpoint image to be displayed can be generated by shifting the reference viewpoint image in opposite directions by the same distance.

In the image interpolation unit 22, interpolation processing is performed on a pixel, to which a pixel value has not been allocated, of each of the reference viewpoint image to be displayed and the different viewpoint image to be displayed that have been generated by the image generation unit 21, and a pixel value is allocated to the pixel. Here, processing similar to that performed by the image interpolation unit 15 of the first embodiment is performed on the reference viewpoint image to be displayed and the different viewpoint image to be displayed. The reference viewpoint image to be displayed and the different viewpoint image to be displayed in each of which pixel values are allocated to all of the pixels by the interpolation are input to the display unit 16.

Since the reference viewpoint image to be displayed and the different viewpoint image to be displayed are generated in the image generation unit 21 by being moved in opposite directions by the same distance, the number of pixels to be interpolated is the same in each of the images. Interpolation processing may sometimes cause deterioration such as blurring, and thus, in the case where blurring occurs in only one of viewpoint images, the blurring may be a cause of a reduction in image quality and a reduction in the ease of stereoscopic viewing. According to the present embodiment, the degree of deterioration in image quality due to interpolation in each of viewpoint images can be suppressed to the same degree by making the number of pixels to be interpolated in each of viewpoint images be the same as each other.

The display unit 16 displays a stereoscopic image that includes the above-described new viewpoint image, which is generated as described above on the basis of the reference viewpoint image, and the above-described new remaining viewpoint image, which is generated as described above on the basis of a different viewpoint image, as display elements.

The second to fifth embodiments, which have been described above, can be applied to the present embodiment, and the configurations and the applications such as, for example, the method of selecting a reference viewpoint image can be also applied to the present embodiment except for the use of a reference viewpoint image as it is at the time of displaying in the first embodiment. Note that the parallax adjustment, which has been described in the fourth embodiment, can also be performed at the time of generating a new viewpoint image that corresponds to a reference viewpoint image. Adjustment can be performed on the new viewpoint image and a new remaining viewpoint image in such a manner that, for example, the width between a maximum value and a minimum value of parallax is reduced overall. Obviously, an adjustment with which a change will not occur in a reference viewpoint image when the adjustment is made may be employed.

As described above, according to the stereoscopic image display device of the present embodiment, a difference of image quality between viewpoint images can be reduced by generating both of the viewpoint images from one of the viewpoint images, and in the case where interpolation is employed, a difference of deterioration caused by the interpolation between the viewpoint images can be reduced.

### Seventh Embodiment

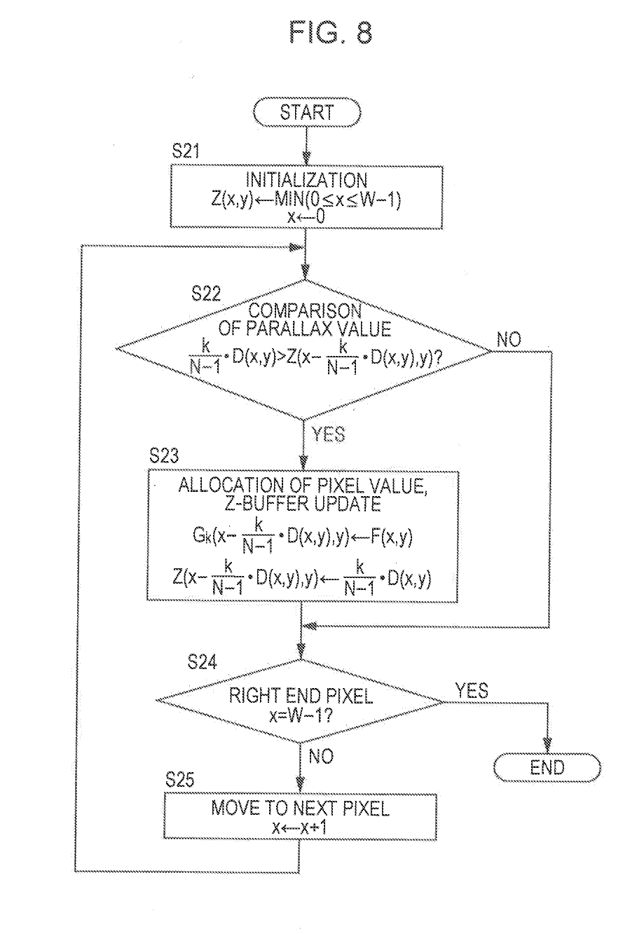

A seventh embodiment of the present invention will be described with reference to FIG. 8. FIG. 8 is a flow diagram for describing an operation example of an image generation unit in a stereoscopic image display device according to the seventh embodiment of the present invention.

The stereoscopic image display device according to the seventh embodiment is a device in which processing is performed in such a manner that the number of viewpoint images (multi-view images to be displayed) that are to be used for displaying in a display unit is greater than the number of viewpoint images that are input from an input unit. In the present embodiment, the number of viewpoints that form an input multi-view image, that is, the number of viewpoint images that are input via the input unit is M (≧2), and the number of viewpoints that form a multi-view image to be displayed, that is, the number of viewpoint images to be displayed is N (≧3). Here, M<N.

The schematic configuration of the stereoscopic image display device according to the seventh embodiment can be illustrated in FIG. 1, and the present embodiment will be described below with reference to FIG. 1. The principal feature of the present embodiment is that the image generation unit 14 further generates a viewpoint image that has a new viewpoint different from the viewpoint of the above-described new remaining viewpoint image (hereinafter referred to as a viewpoint image of a new viewpoint) from a parallax map and a reference viewpoint image. The display unit 16 displays a stereoscopic image in which the viewpoint image of a new viewpoint is also a display element, that is, a stereoscopic image that also includes the above-described viewpoint image of a new viewpoint as a display element.

The case where such processing is applied to the first embodiment while M=2 as in the first embodiment will be described below. Note that, basically, the contents described in the first embodiment can be applied to part of the processing the description of which will be omitted.

In the input unit 11, the reference viewpoint image selection unit 12, and the parallax calculation unit 13, the processing is performed by a method similar to that of the first embodiment. In other words, in the reference viewpoint image selection unit 12, input images that are formed of a left-eye image and a right-eye image are input via the input unit 11, and a reference viewpoint image is selected. In the parallax calculation unit 13, calculation of a parallax map of a viewpoint image other than the reference viewpoint image is performed.

Then, in the image generation unit 14, N−1 different viewpoint images to be displayed are generated from the reference viewpoint image and one parallax map that has been calculated in the parallax calculation unit 13 and are output to the image interpolation unit 15.

A procedure of a generation method of the image generation unit 14 will be described with reference to FIG. 8. FIG. 8 is an example in which a left-eye image is selected as a reference viewpoint image. Although in a manner similar to FIG. 2, (x, y) represents coordinates in the image, FIG. 8 illustrates a process that is performed in each of rows, and y is constant. F, Gₖ, and D represent a reference viewpoint image, a k-th different viewpoint image to be displayed, and a parallax map, respectively. Here, the process is to be performed in each of the cases where k is any one of 1 to N−1. Similarly to FIG. 2, Z and W are a z-buffer and the number of pixels of the image in the lateral direction.

In step S22, a parallax value of the parallax map and a z-buffer value of a pixel having coordinates that have been moved by a value that is k/(N−1) times the parallax value are compared so as to determine whether the value that is k/(N−1) times the parallax value is larger than the z-buffer value or not. In the case where the value, which is k/(N−1) times the parallax value, is larger than the z-buffer value, the process continues to step S23, and the pixel value of the reference viewpoint image F is allocated to the k-th different viewpoint image to be displayed Gₖ. However, the pixel value of the reference viewpoint image F is allocated to the coordinates that are moved by the value, which is k/(N−1) times the parallax value, from coordinates (x, y). In addition, regarding the z-buffer, the value of the coordinates that are moved by the value, which is k/(N−1) times the parallax value, is updated, and the process continues to step S24. In step S22, in the case where the value, which is k/(N−1) times the parallax value, is the z-buffer value or smaller, the process continues to step S24 without performing step S23.

The procedure of FIG. 8 is performed on all of the rows, so that one reference viewpoint image to be displayed can be generated. In addition, the above-described processing is performed in all of the cases where k is any one of 1 to N−1, so that N−1 different viewpoint images to be displayed can be generated. The N−1 different viewpoint images to be displayed that are to be generated are formed of the above-described M−1 (one in this example) new remaining viewpoint images that correspond to the above-described remaining viewpoint images and N−M (N−2 in this example) viewpoint images of a new viewpoint.

In the image interpolation unit 15 performs interpolation processing on pixels, to each of which a pixel value has not been allocated, of the N−1 different viewpoint images to be displayed that have been generated in the image generation unit 14 and allocates a pixel value to each of the pixels. In other words, processing that is similar to that of the image interpolation unit 15 of the first embodiment is performed on each of the pixels. The N−1 different viewpoint images to be displayed in which pixel values are allocated to all of the pixels by the interpolation and the reference viewpoint image are input to the display unit 16.

Although the example in which input images are two viewpoint images (M=2) has been described above, the present embodiment can be applied also to the fifth embodiment. In the case where the number M of input images is three or greater as in the fifth embodiment, as described above, (N−1)/(M−1) different viewpoint images to be displayed are generated for one parallax map from a reference viewpoint image and M−1 parallax maps that are calculated in the parallax calculation unit 13, and eventually, stereoscopic image display may be performed by using one reference viewpoint image and the N−1 different viewpoint images to be displayed as display elements.

Generation of a different viewpoint image to be displayed in the case where M=3 will be described as an example. In the case where one of three input viewpoint images that has a central viewpoint is determined as a reference viewpoint image, (N−1)/(M−1) different viewpoint images to be displayed may be generated on the left side and on the right side in a similar manner. On the other hand, in the case where an input viewpoint image B from which a different parallax map Db is calculated is present between an input viewpoint image A from which one parallax map Da is calculated and a reference viewpoint image R, that is, in the case where an input viewpoint image of an end viewpoint is a reference viewpoint image, processing may be performed as follows. In other words, regarding viewpoints from the input viewpoint image B to the reference viewpoint image R, the (N−1)/(M−1) different viewpoint images to be displayed may be generated from the reference viewpoint image R and the parallax map Db as described above. Regarding viewpoints from an image A to the reference viewpoint image R, the (N−1)/(M−1) different viewpoint images to be displayed may be generated from the reference viewpoint image R and the parallax map Da by using only k with respect to viewpoints from the image A to an image B.

In the above description of the present embodiment in the case where M≧3, although the numbers of different viewpoint images to be displayed that are generated for the parallax maps is the same ((N−1)/(M−1) in this example), the numbers need not be the same, and different numbers of different viewpoint images to be displayed may be generated for the parallax maps. In addition, although the description of the present embodiment in the case where M≧3, is based on the assumption that intervals between viewpoints between different viewpoint images to be displayed are constant angles, in the case where it is desired that such constant angles not be made, processing according to angles may be performed.

As described above, in the present embodiment, regarding viewpoints of M≧2) input viewpoint images that are input, viewpoint images that correspond to the viewpoints are always present as display elements, and in addition, a viewpoint image of a new viewpoint for showing a new viewpoint is also present as a display element. It can be said that the viewpoint image of a new viewpoint is an image for interpolating a viewpoint.

In the present embodiment, although the example in which interpolation is used as a method of generating different viewpoint images to be displayed including the above-described viewpoint image of a new viewpoint for interpolating a viewpoint is described, extrapolation may be applied in a part of the processing or in the entire processing. Stereoscopic display that has a viewpoint wider than that of an input image can be performed by applying extrapolation, and advantageous effects similar to those when parallax is increased in the case where parallax adjustment that has been described as the fourth embodiment is employed can be obtained.

In addition, the viewpoint image generation processing of the present embodiment can be applied to the first and fifth embodiments as described above and can be applied also to the second to sixth embodiments.

In particular, as in the sixth embodiment, in the case where a new viewpoint image is generated also from a reference viewpoint image, when M=2, a total of N different viewpoint images to be displayed that are to be generated are formed of the above-described one new viewpoint image that corresponds to a viewpoint image that is selected as a reference viewpoint image, the above-described M−1 (i.e., one) new remaining viewpoint image that corresponds to the above-described remaining viewpoint image, and N−M (i.e., N−2) viewpoint images of a new viewpoint. Here, even in the case where M≧3 as a result of applying the fifth embodiment, a total of N different viewpoint images to be displayed can be generated by having uniform viewpoints (constant angle viewpoints), and a stereoscopic image that includes the different viewpoint images as display elements can be displayed.

As described above, according to the present embodiment, even in the case where processing is performed in such a manner that the number of viewpoint images that are to be input and the number of viewpoint images that are to be used for display are different from each other, a stereoscopic image in which a difference other than parallax is reduced can be displayed by generating the number of viewpoint images required for display from one viewpoint image (a reference viewpoint image).

### (Regarding First to Seventh Embodiments)

Although the stereoscopic image display devices according to the first to seventh embodiments of the present invention have been described above, the present invention may employ a form of a stereoscopic image display device that is formed by removing a display device from such a stereoscopic image display device. In other words, a display device that displays a stereoscopic image may be mounted in a main body of the stereoscopic image processing device according to the present invention or may be connected to the outside. Such a stereoscopic image processing device can be built in a television device or a monitoring device and alternatively can be built in other video output devices such as various recorders and various recording medium reproducing devices.

Among the units of each of the stereoscopic image display devices 1 and 4 to 6, which are illustrated in FIG. 1 and FIGS. 4 to 6, a portion that corresponds to the stereoscopic image processing device according to the present invention (i.e., a component except for the display device that is included in the display unit 16) can be realized by, for example, hardware such as a microprocessor (or DSP: Digital Signal Processor), a memory, a bus, an interface, and a peripheral device and software that is executable on these hardware. A part or all of the above-described hardware can be mounted as an integrated circuit/IC (Integrated Circuit) chip set, and in this case, it is only necessary that the above-described software may be stored in the above-described memory. All of the components of the present invention may be formed of hardware, and in this case, similarly, a part or all of the hardware can be mounted as an integrated circuit/IC chip set.

The stereoscopic image processing device according to each of the embodiments can be simply formed of memory devices such as a CPU (Central Processing Unit), a RAM (Random Access Memory) serving as a work area, a ROM (Read Only Memory) serving as a storage area for a control program, an EEPROM (Electrically Erasable Programmable ROM) and the like. In this case, the above-described control program includes a stereoscopic image processing program for executing the processing according to the present invention, which will be described below. This stereoscopic image processing program can cause a PC to function as a stereoscopic image processing device by being built in the PC as application software for displaying a stereoscopic image.

Although the stereoscopic image processing device according to the present invention has been mainly described above, the present invention may employ a form as a stereoscopic image processing method as in the example of the flow of control in a stereoscopic image display device that includes the stereoscopic image processing device, which has been described. The stereoscopic image processing method includes steps of selecting one of a plurality of viewpoint images as a reference viewpoint image by using a reference viewpoint image selection unit, calculating a parallax map between the reference viewpoint image and the remaining viewpoint image by using a parallax calculation unit, generating a new remaining viewpoint image that corresponds to at least the remaining viewpoint image from the parallax map and the reference viewpoint image by using an image generation unit, and displaying a stereoscopic image that includes at least the new remaining viewpoint image as a display element by using a display control unit. The description of a stereoscopic image processing device may be applied in other applications.

In addition, the present invention may employ a form as a stereoscopic image processing program that causes a computer to execute the stereoscopic image processing method. In other words, the stereoscopic image processing program is a program that causes a computer to execute steps of selecting one of a plurality of viewpoint images as a reference viewpoint image, calculating a parallax map between the reference viewpoint image and the remaining viewpoint image, generating a new remaining viewpoint image that corresponds to at least the remaining viewpoint image from the parallax map and the reference viewpoint image, and displaying a stereoscopic image that includes at least the new remaining viewpoint image as a display element. The description of a stereoscopic image display device may be applied in other applications.

A form as a program recording medium in which the stereoscopic image processing program is recorded in a computer-readable recording medium can also be easily understood. As described above, the computer is not limited to a versatile PC, and computers in various forms such as a microcomputer, a programmable versatile integrated circuit/chip set and the like can be applied as the computer. In addition, the program can be distributed via a transportable recording medium and also can be distributed via a network such as internet or via a broadcast wave. Receiving via a network means to receive a program that is recorded in a memory device of an external server or the like.

### REFERENCE SIGNS LIST

1, 4, 5, 6 stereoscopic image display device
11 input unit
12, 19 reference viewpoint image selection unit
13 parallax calculation unit
14, 21 image generation unit
15, 22 image interpolation unit
16 display unit
17 scene change detection unit
18 storage unit
20 parallax distribution conversion unit

1-13. (canceled)

14. A stereoscopic image processing device comprising:
a reference viewpoint image selection unit that selects one of a plurality of viewpoint images as a reference viewpoint image;
a parallax calculation unit that calculates a parallax map between the reference viewpoint image and the remaining viewpoint image;
an image generation unit that generates a new remaining viewpoint image that corresponds to at least the remaining viewpoint image from the parallax map and the reference viewpoint image; and
a display control unit that displays a stereoscopic image that includes at least the new remaining viewpoint image as a display element,
wherein the image generation unit further generates a new viewpoint image that corresponds to the reference viewpoint image from the parallax map and the reference viewpoint image, and
wherein the display control unit displays a stereoscopic image that includes the new viewpoint image and the new remaining viewpoint image as display elements.

15. The stereoscopic image processing device according to claim 14,
wherein the reference viewpoint image selection unit selects the reference viewpoint image by using image feature amounts of the plurality of viewpoint images.

16. The stereoscopic image processing device according to claim 15,
wherein one of the image feature amounts is contrast.

17. The stereoscopic image processing device according to claim 15,
wherein one of the image feature amounts is sharpness.

18. The stereoscopic image processing device according to claim 15,
wherein one of the image feature amounts is the number of flesh color pixels in a periphery of an image.

19. The stereoscopic image processing device according to claim 14,
wherein the reference viewpoint image selection unit selects a viewpoint image of a predetermined viewpoint as the reference viewpoint image.

20. The stereoscopic image processing device according to claim 14,
wherein the image generation unit performs parallax adjustment in a case of generating the new remaining viewpoint image from the parallax map and the reference viewpoint image.

21. The stereoscopic image processing device according to claim 14,
wherein the image generation unit further generates a viewpoint image of a new viewpoint that has a new viewpoint different from a viewpoint of the new remaining viewpoint image from the parallax map and the reference viewpoint image, and
wherein the display control unit displays a stereoscopic image that also includes the viewpoint image of a new viewpoint as a display element.

22. A stereoscopic image processing device comprising:
a reference viewpoint image selection unit that selects one of a plurality of viewpoint images as a reference viewpoint image;
a parallax calculation unit that calculates a parallax map of the reference viewpoint image and the remaining viewpoint image;
an image generation unit that generates a new remaining viewpoint image that corresponds to at least the remaining viewpoint image from the parallax map and the reference viewpoint image; and
a display control unit that displays a stereoscopic image that includes at least the new remaining viewpoint image as a display element,
wherein the plurality of viewpoint images are frame images that form a moving picture,
wherein the stereoscopic image processing device further comprises a scene change detection unit, and
wherein the reference viewpoint image selection unit selects a viewpoint image of a viewpoint that is the same as that of a previous frame image as the reference viewpoint image in a case where a scene change is not detected in the scene change detection unit.

23. The stereoscopic image processing device according to claim 22,
wherein the image generation unit performs parallax adjustment in a case of generating the new remaining viewpoint image from the parallax map and the reference viewpoint image.

24. The stereoscopic image processing device according to claim 22,
wherein the image generation unit further generates a viewpoint image of a new viewpoint that has a new viewpoint different from a viewpoint of the new remaining viewpoint image from the parallax map and the reference viewpoint image, and
wherein the display control unit displays a stereoscopic image that also includes the viewpoint image of a new viewpoint as a display element.

25. A stereoscopic image processing method comprising the steps of:
selecting one of a plurality of viewpoint images as a reference viewpoint image by using a reference viewpoint image selection unit;
calculating a parallax map between the reference viewpoint image and the remaining viewpoint image by using a parallax calculation unit;
generating a new remaining viewpoint image that corresponds to the remaining viewpoint image from the parallax map and the reference viewpoint image by using an image generation unit;
further generating a new viewpoint image that corresponds to the reference viewpoint image from the parallax map and the reference viewpoint image by using the image generation unit; and
displaying a stereoscopic image that includes the new viewpoint image and the new remaining viewpoint image as a display elements by using a display control unit.

26. A non-transitory computer readable recording medium recording a program causing a computer to execute a stereoscopic image process, the stereoscopic image process comprising the steps of:
selecting one of a plurality of viewpoint images as a reference viewpoint image;
calculating a parallax map between the reference viewpoint image and the remaining viewpoint image;
generating a new remaining viewpoint image that corresponds to the remaining viewpoint image from the parallax map and the reference viewpoint image; and
further generating a new viewpoint image that corresponds to the reference viewpoint image from the parallax map and the reference viewpoint image; and
displaying a stereoscopic image that includes the new viewpoint image and the new remaining viewpoint image as a display elements.
